(19) United States
(12) Patent Application Publication
(10) Pub. No.: US 2026/0025513 A1
(43) Pub. Date: Jan. 22, 2026

(54) METHOD AND DEVICE FOR VIDEO CODING USING REARRANGEMENT OF PREDICTION SIGNALS IN INTRA BLOCK COPY MODE

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Sea Nae Park, Uijeongbu-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 18/998,065

(22) PCT Filed: Jul. 13, 2023
(86) PCT No.: PCT/KR2023/010023

§ 371 Date: Jan. 23, 2025

(30) Foreign Application Priority Data
Aug. 9, 2022 (KR) 10-2022-0099353
Jul. 11, 2023 (KR) 10-2023-0089974

(51) Int. Cl. H04N 19/159; H04N 19/119; H04N 19/176

(52) U.S. Cl. CPC H04N 19/159; H04N 19/119; H04N 19/176

(57) ABSTRACT

A method and an apparatus are disclosed for video coding using reordering of predicted signals in intra block copy mode. In the disclosed embodiments, a video decoding device obtains a splitting direction of the current block and obtains a ratio of subblocks with respect to the current block. Here, the splitting direction indicates a horizontal split or a vertical split. The video decoding device generates an initial prediction block of the current block according to an intra block copy (IBC) mode. The video decoding device splits the initial prediction block into subblocks based on the splitting direction and the ratio of the subblocks and generates a final prediction block of the current block by reordering the subblocks.

### TECHNICAL FIELD

The present disclosure relates to a video coding method and an apparatus using reordering of predicted signals in intra block copy mode.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra block copy (IBC) mode when performing the prediction of the current block, uses the parsed block vector information to generate the prediction block of the current block from the reconstructed region in the current frame. IBC mode is divided into merge mode and advanced motion vector predictor (AMVP) mode. In merge mode, the encoder signals the merge index, and in AMVP mode, the encoder signals the index that indicates the block vector predictor (BVP) and the block vector difference (BVD). In IBC mode as described above, the current block is processed as a single block. Therefore, to increase video coding efficiency and enhance video quality, there is a need to consider utilizing subblocks of the current block.

### DISCLOSURE

### Technical Problem

The present disclosure seeks to provide a video coding method and an apparatus for reconstructing a current block by reordering initial predicted signals when the predicted signals of the current block are generated from a reconstructed region in the current frame by using a block vector.

### Technical Solution

At least one aspect of the present disclosure provides a method of reconstructing a current block by a video decoding device. The method includes obtaining a splitting direction of the current block and the splitting direction indicates a horizontal split or a vertical split. The method also includes obtaining a ratio of subblocks with respect to the current block. The method also includes generating an initial prediction block of the current block according to an intra block copy (IBC) mode. The method also includes splitting the initial prediction block into subblocks based on the splitting direction and the ratio of the subblocks. The method also includes generating a final prediction block of the current block by reordering the subblocks.

Another aspect of the present disclosure provides a method of encoding a current block by a video encoding device. The method includes generating an initial prediction block of the current block according to an intra block copy (IBC) mode. The method also includes obtaining a splitting direction of the current block and the splitting direction indicates a horizontal split or a vertical split. The method also includes obtaining a ratio of subblocks with respect to the current block. The method also includes splitting the initial prediction block into subblocks based on the splitting direction and the ratio of the subblocks. The method also includes generating a final prediction block of the current block by reordering the subblocks.

Yet another aspect of the present disclosure provides a computer-readable recording medium storing a bitstream generated by a video encoding method. The video encoding method includes generating an initial prediction block of a current block according to an intra block copy (IBC) mode. The video encoding method includes obtaining a splitting direction of the current block and the splitting direction indicates a horizontal split or a vertical split. The video encoding method includes obtaining a ratio of subblocks with respect to the current block. The video encoding method includes splitting the initial prediction block into subblocks based on the splitting direction and the ratio of the subblocks. The video encoding method includes generating a final prediction block of the current block by reordering the subblocks.

### Advantageous Effects

As described above, the present disclosure provides a video coding method and an apparatus that reconstruct a current block by reordering initial predicted signals when the predicted signals of the current block are generated from a reconstructed region in the current frame by using a block vector. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram detailing a portion of a video decoding device, according to at least one embodiment of the present disclosure.

FIG. 7 is a flowchart of a method performed by a video decoding device for predicting a current block based on an IBC (intra block copy) mode, according to at least one embodiment of the present disclosure.

FIG. 8 is a diagram illustrating vertically partitioned subblocks, according to at least one embodiment of the present disclosure.

FIG. 9 is a diagram illustrating horizontally partitioned subblocks, according to at least one embodiment of the present disclosure.

FIGS. 10 through 13 are diagrams illustrating the reordering of initial prediction blocks, according to some embodiments of the present disclosure.

FIG. 14 is a flowchart of a method performed by a video decoding device for predicting a current block based on an IBC mode, according to another embodiment of the present disclosure.

FIG. 15 is a diagram illustrating vertically or horizontally partitioned subblocks, according to at least one embodiment of the present disclosure.

FIGS. 16A and 16B are diagrams illustrating the application of filtering to subblock boundaries, according to at least one embodiment of the present disclosure.

FIGS. 17A and 17B are diagrams illustrating the application of filtering to subblock boundaries, in accordance with another embodiment of the present disclosure.

FIG. 18 is a flowchart of a method performed by a video encoding device for predicting a current block based on an IBC mode, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

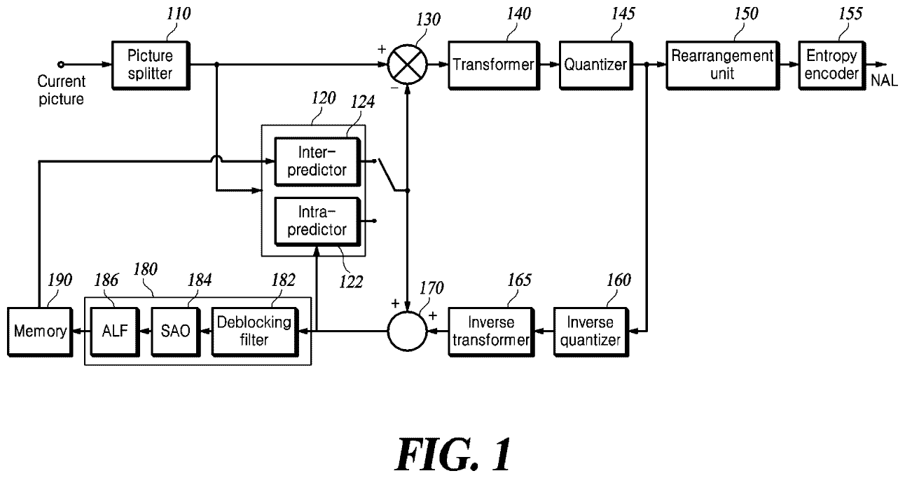

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

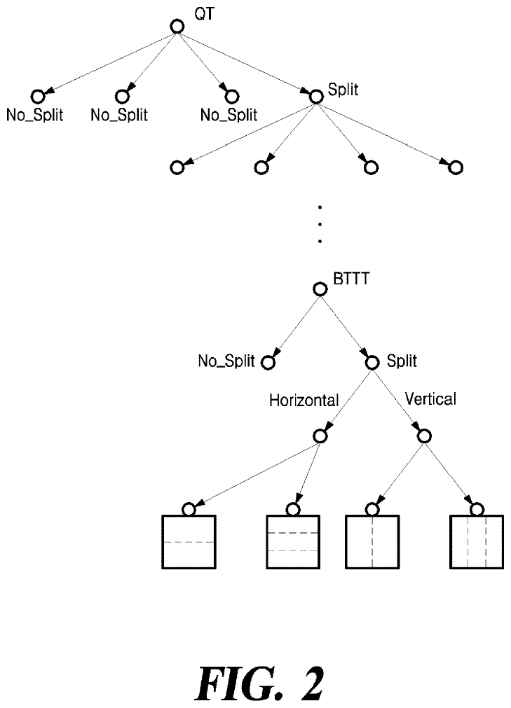

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

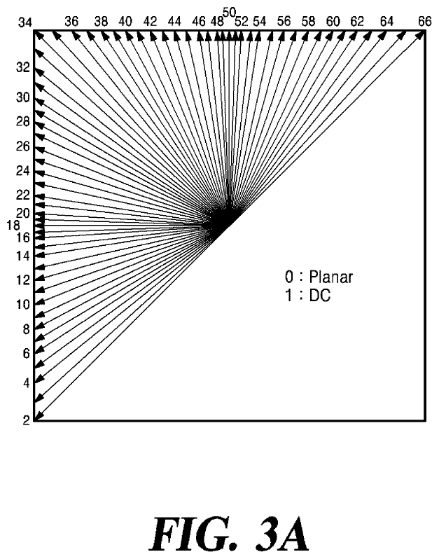

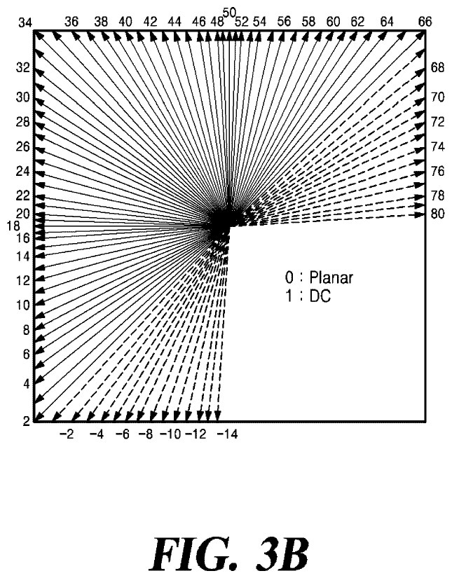

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

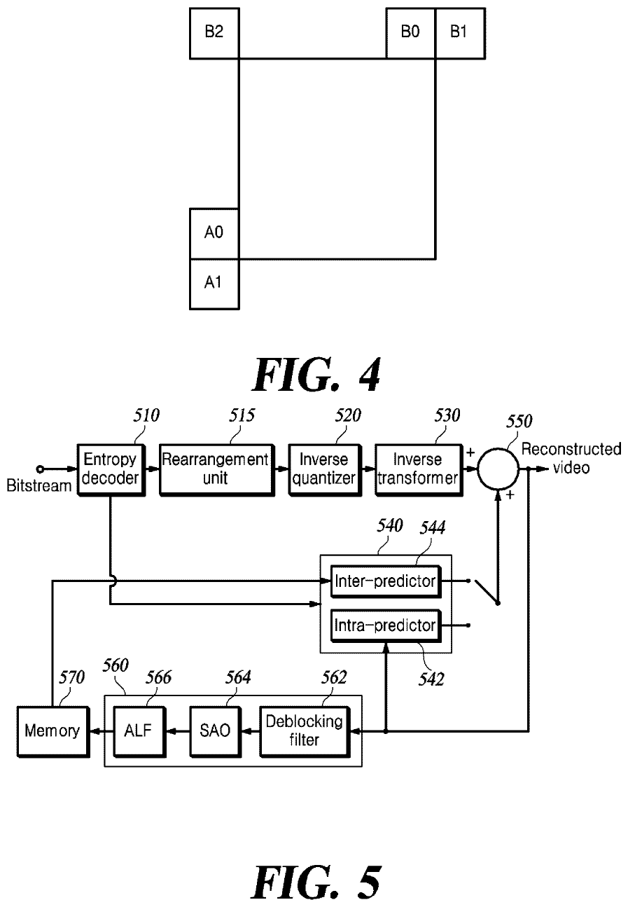

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for reconstructing a current block by reordering initial predicted signals when the predicted signals of the current block are generated from a reconstructed region in the current frame by using a block vector.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Block Copy (IBC)

The IBC performs intra prediction of the current block by copying a reference block in the same frame by using a block vector to generate a prediction block of the current block.

The video encoding device performs block matching to derive an optimal block vector. Here, the block vector represents a displacement from the current block to the reference block. To increase coding efficiency, the video encoding device may not transmit the block vector as is, but may split it into a block vector predictor (BVP) and a block vector difference (BVD), and encode and then transmit the BVP and the BVD to the video decoding device.

Hereinafter, the BVD and the block vector are considered to have the same spatial resolution.

In terms of utilizing block vectors, the IBC has the characteristics of inter prediction. Therefore, IBC may be categorized into IBC merge/skip mode and IBC AMVP mode.

In the case of IBC merge/skip mode, the video encoding device first composes an IBC merge list. In terms of optimizing coding efficiency, the video encoding device may select a block vector of one of the candidates included in the IBC merge list and use the selected bock vector as a block vector predictor (BVP). The video encoding device determines a merge index that indicates the selected block vector. However, the video encoding device does not generate a BVD. The video encoding device encodes and transmits the merge index to the video decoding device. The IBC merge list may be composed in the same way by the video encoding device and the video decoding device. After decoding the merge index, the video decoding device may use the merge index to generate a block vector from the IBC merge list.

The video encoding device, in the case of the IBC skip mode, utilizes the same method for block vector transmission as with the IBC merge mode but does not transmit a residual block corresponding to the difference between the current block and the prediction block.

When in IBC AMVP mode, the video encoding device determines a block vector and composes an IBC AMVP list in terms of optimizing coding efficiency. The video encoding device determines a candidate index that indicates one of the candidate block vectors included in the IBC AMVP list, as the BVP (block vector predictor). The video encoding device calculates the BVD (block vector difference) which is the difference between the BVP and the block vector. The video encoding device then encodes and transmits the candidate index and the BVD to the video decoding device.

On the other hand, the video decoding device decodes the candidate index and the BVD. Upon obtaining the BVP indicated by the candidate index from the IBC AMVP list, the video decoding device may sum the BVP and the BVD to reconstruct the block vector.

The following embodiments are described with reference to the video decoding device but may be implemented equally or similarly in the video encoding device.

### II. Embodiments According to the Present Disclosure

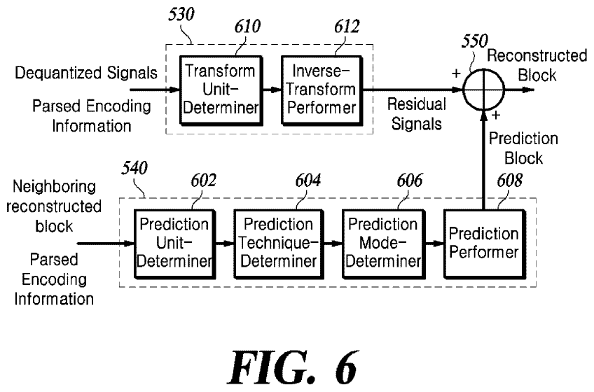

FIG. 6 is a block diagram detailing a portion of the video decoding device, according to at least one embodiment of the present disclosure.

The video decoding device according to some embodiments can determine prediction unit and transform unit, and for a current block corresponding to the determined unit, perform a prediction and an inverse transform by using a determined prediction technique and prediction mode, to finally generate a reconstructed block of the current block. The operations illustrated in FIG. 6 may be performed by an inverse transformer 530, a predictor 540, and an adder 550 of the video decoding device. On the other hand, the same operations as illustrated in FIG. 6 may be performed by the inverse transformer 165, the picture splitter 110, the predictor 120, and the adder 170 of the video encoding device. In this case, the video decoding device uses encoding information parsed from the bitstream, but the video encoding device may use encoding information set from a higher level in terms of minimizing rate distortion. Hereinafter, for convenience, the embodiments are described centering on the video decoding device.

As illustrated in FIG. 5, the predictor 540 includes the intra predictor 542 and the inter predictor 544, depending on the prediction technique, but as illustrated in FIG. 6, the predictor 540 may include all or part of a prediction unit-determiner 602, a prediction technique-determiner 604, a prediction mode-determiner 606, and a prediction performer 608.

The prediction unit-determiner 602 determines a prediction unit (PU). The prediction technique-determiner 604, with respect to the prediction unit, determines a prediction technique, e.g., intra prediction, inter prediction, or intra block copy (IBC) mode, palette mode, or the like. The prediction mode-determiner 606 determines a detailed prediction mode for the prediction technique. The prediction performer 608 generates a prediction block of the current block according to the determined prediction mode.

The inverse transformer 530 includes a transform unit-determiner 610 and an inverse transform-performer 612. The transform unit-determiner 610 determines a transform unit (TU) in response to the inverse quantization signals of the current block, and the inverse transform-performer 612 inversely transforms the transform unit represented by the inverse quantization signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 602 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed for the prediction unit of the chroma component.

The prediction technique-determiner 604 determines a prediction technique for the prediction units. As described above, the prediction technique may be one of inter prediction, intra prediction, IBC mode, and palette mode.

In one example, if the prediction technique of the current block is not intra prediction, the video decoding device parses the 1-bit flag information. If the parsed flag indicates a skip mode, the video decoding device may determine the prediction mode of the current block to be an inter prediction merge mode or an IBC merge mode. The video decoding device may also use the predicted signals as reconstructed signals, skipping an inverse transform.

On the other hand, if the parsed flag does not indicate a skip mode for the current block, the prediction technique-determiner 604 may determine one of the prediction techniques, such as inter prediction, intra prediction, IBC mode, palette mode, or the like, by parsing a series of 1-bit flags with respect to the prediction technique of the current block. Hereinafter, the flag indicating whether IBC mode is to be applied is referred to as an IBC flag.

For example, if skip mode is not applied to the current block and it is determined to be inter prediction or IBC mode, the prediction mode-determiner 606 may parse a 1-bit flag and determine, based on the parsed flag, the prediction mode of the current block to be merge mode or AMVP mode.

If the prediction mode of the current block is IBC mode, the prediction mode-determiner 606 may parse the 1-bit flag and determine, based on the parsed flag which is referred to as ‘reorder flag’ hereinafter, whether to use a mode for reordering the initial predicted signals to generate the final predicted signals, which is referred to as ‘reordering prediction mode’ hereinafter. First, the video decoding device generates the initial prediction block of the current block by using the block vector. Then, if the reorder flag is true and the reordering prediction mode is used, the video decoding device may generate the final prediction block by splitting the initial prediction block into multiple subblocks and reordering the subblock positions.

The following describes the operation of the prediction performer 608 when the prediction technique of the current block is IBC mode and the prediction mode is reordering prediction mode. Hereinafter, the video decoding device refers to the prediction performer 608.

Since the prediction technique of the current block is IBC mode, the video decoding device may generate the block vectors in IBC merge mode as described above or generate the unidirectional block vector according to the IBC AMVP mode. Further, the video decoding device may generate bidirectional block vectors according to the IBC merge mode/IBC AMVP mode. For example, one block vector may be generated according to the IBC merge mode and the other block vector may be generated according to the IBC AMVP mode. Alternatively, the video decoding device may generate the block vectors only in IBC merge mode or only in IBC AMVP mode. As described above, when in IBC merge mode, the video encoding device signals the merge index. Additionally, when in the IBC AMVP mode, the video encoding device may signal the candidate index and block vector difference. The video decoding device may parse the transmitted parameters and generate a block vector by using the parsed parameters.

As an example, the video encoding device and the video decoding device may compose a candidate block vector list by using motion information of reconstructed blocks in the spatial neighborhood of the current block, motion information in blocks encoded before the current block in the encoding order, zero motion information, and the like, as illustrated in FIG. 4. When in the IBC merge mode, the video decoding device may generate a block vector by using the merge index. When in the IBC AMVP mode, the video decoding device may use the candidate index to derive a block vector predictor and then compensate for the block vector difference to thereby generate a block vector. In this case, some of the positions of the reconstructed blocks in the spatial neighborhood of the current block illustrated in FIG. 4 may be omitted or changed.

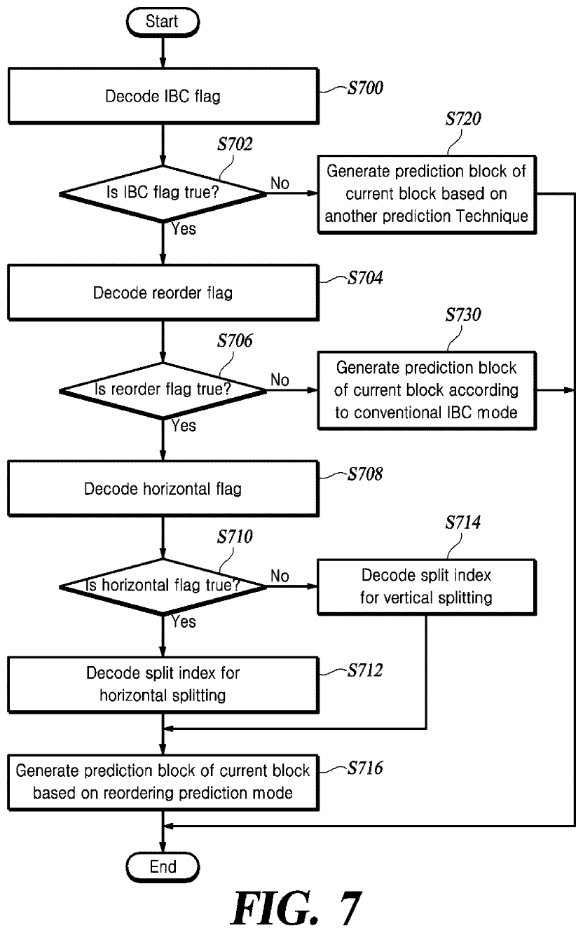

FIG. 7 is a flowchart of a method performed by the video decoding device for predicting the current block based on the IBC mode, according to at least one embodiment of the present disclosure.

The video decoding device decodes the IBC flag from the bitstream (S700). Here, the IBC flag (IBC_flag) is adapted to indicate whether IBC mode is to be applied, as described above.

The video decoding device checks the IBC flag (S702).

If the IBC flag is true (Yes in S702), the video decoding device decodes the reorder flag from the bitstream (S704).

The video decoding device checks the reorder flag (S706). Here, the reorder flag (reorder_flag) indicates whether the reordering prediction mode is to be enabled or disabled.

If the reorder flag is true (Yes in S706), the video decoding device decodes the horizontal flag from the bitstream (S708). Here, the horizontal flag (hor_flag) indicates whether the current block is to be split horizontally or vertically.

The video decoding device checks the horizontal flag (S710).

If the horizontal flag is true (Yes in S710), the video decoding device decodes a split index (split_idx) for horizontally splitting the current block according to the reordering prediction (S712). Here, the split index indicates one of the preset proportions of the subblocks with respect to the horizontally split subblocks. The subblock ratios according to the split index may be those as illustrated in Table 1.

TABLE 1

| split_idx | Subblock ratio |
|---|---|
| 0 | 1:1 |
| 1 | 1:2:1 |
| 2 | 1:3 |
| 3 | 3:1 |

On the other hand, if the horizontal flag is false (No in S710), the video decoding device decodes a split index (split_idx) for vertically splitting the current block according to the reordering prediction (S714). Here, the split index indicates one of the preset ratios of subblocks with respect to the vertically split subblocks. The subblock ratios according to the split index may be those as illustrated in Table 1.

The video decoding device generates a prediction block of the current block based on the reordering prediction mode (S716).

On the other hand, if the IBC flag is false (No in S702), the video decoding device generates the prediction block of the current block based on another prediction technique such as intra prediction, inter prediction, or the like. (S720).

Further, if the reorder flag is false (No in S706), the video decoding device generates the prediction block of the current block according to a conventional IBC mode that does not utilize the reordering prediction mode (S730).

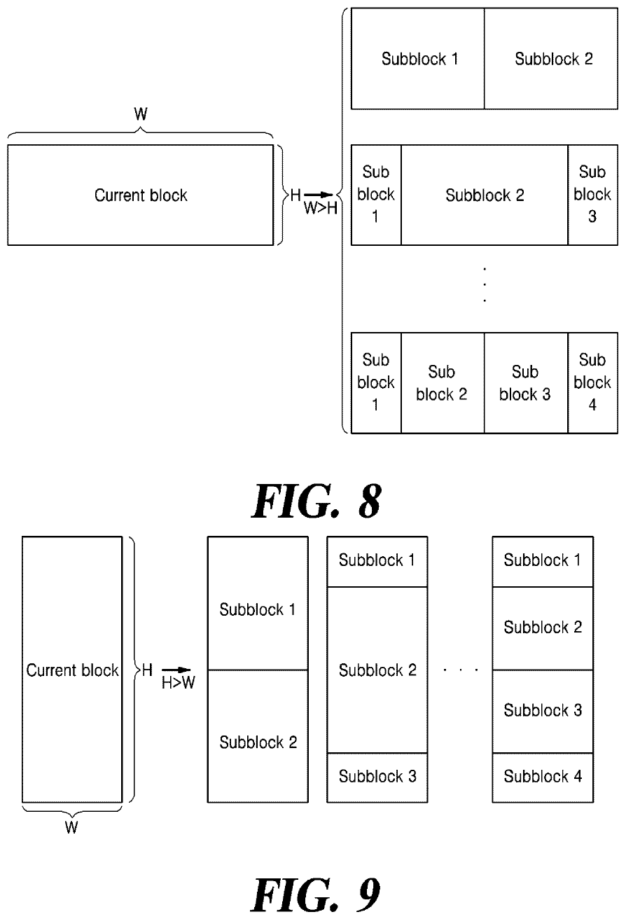

In one example, the size (or, aspect ratio) of the current block may implicitly determine the splitting direction of the subblocks for performing the reordering prediction. This section describes the case where the current block prediction technique is IBC mode and the current block is predicted according to the reordering prediction mode. With respect to a current block having a size W×H (where W is the width and H is the height), if W>H, the video decoding device may generate vertically split subblocks, as illustrated in FIG. 8. Alternatively, if W<H, the video decoding device may generate subblocks split along a horizontal direction, as illustrated in FIG. 9.

In one example, if the splitting direction of the subblocks for performing the reordering prediction is implicitly determined based on the size of the current block, or explicitly determined based on the parsed horizontal flag as in the example of FIG. 7, the subblock ratio (i.e., the split index) may be implicitly determined based on the aspect ratio of the current block. Alternatively, the subblock ratio may be explicitly determined based on the signaled and parsed split index, as illustrated in FIG. 7. As described above, the subblock ratios according to the split index may be illustrated as in Table 1.

This section describes the step (S716) of generating a prediction block of the current block, in which a splitting direction of the subblocks for performing the reordering prediction is implicitly determined according to a size of the current block, or explicitly determined according to a parsed horizontal flag, as illustrated in FIG. 7, and a subblock ratio is implicitly or explicitly determined. After generating the block vector of the current block based on the IBC merge mode or the IBC AMVP mode, the video decoding device may use the generated block vector to perform a prediction of the current block based on the reordering prediction mode as follows.

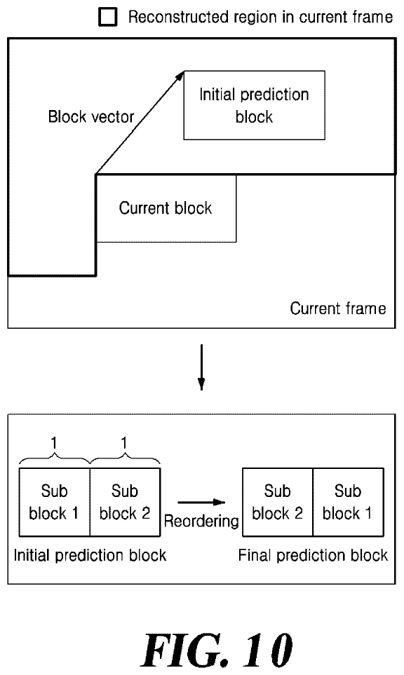

In one example, when the current block is implicitly or explicitly vertically split and the subblock ratio is implicitly or explicitly determined to be 1:1, the video decoding device first generates an initial prediction block by using the block vector, as illustrated in FIG. 10. The video decoding device vertically splits the initial prediction block to generate two subblocks. The video decoding device may then perform a reordering to change the order of the two subblocks to generate a final prediction block of the current block.

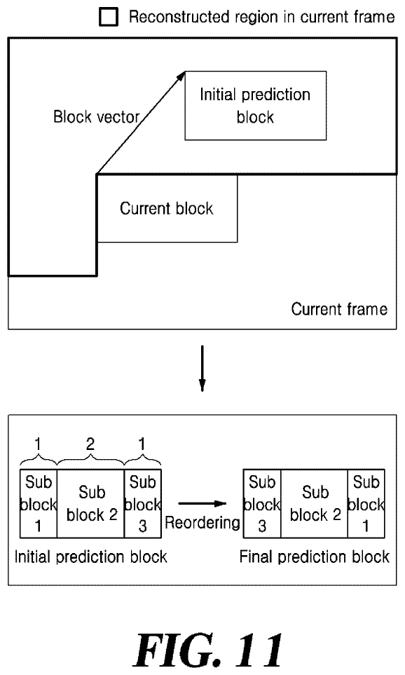

As another example, if the current block is implicitly or explicitly vertically partitioned and the subblock ratio is implicitly or explicitly determined to be 1:2:1, the video decoding device may first generate an initial prediction block by using a block vector, as illustrated in FIG. 11. The video decoding device vertically splits the initial prediction block to generate three subblocks. The video decoding device may then perform a reordering to change the order of the three subblocks to generate a final prediction block of the current block. In the example of FIG. 11, among the three subblocks, the blocks that are reordered are subblock 1 and subblock 3, which are located on either side of the initial prediction block. The centrally located subblock 2 may not be reordered.

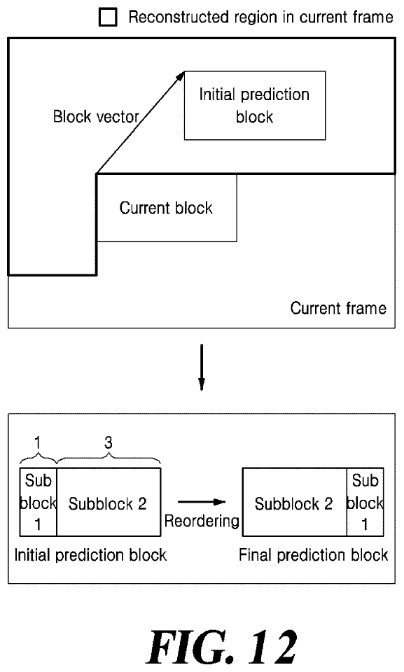

As yet another example, if the current block is implicitly or explicitly vertically split and the subblock ratio is implicitly or explicitly determined to be 1:3, the video decoding device first generates an initial prediction block by using the block vector, as illustrated in FIG. 12. The video decoding device vertically splits the initial prediction block to generate two subblocks. The video decoding device may then perform a reordering to change the order of the two subblocks to generate a final prediction block of the current block.

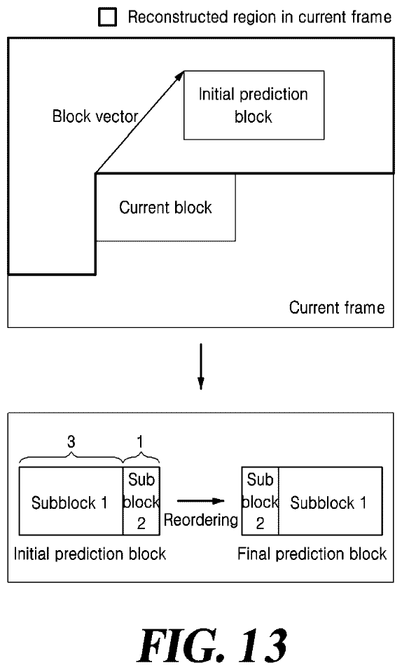

As yet another example, if the current block is implicitly or explicitly vertically partitioned and the subblock ratio is implicitly or explicitly determined to be 3:1, the video decoding device may first generate an initial prediction block by using the block vector, as illustrated in FIG. 13. The video decoding device vertically splits the initial prediction block to generate two subblocks. The video decoding device may then perform a reordering to change the order of the two subblocks to generate a final prediction block of the current block.

Further, if the current block is implicitly or explicitly horizontally split and the subblock ratio is implicitly or explicitly determined, the video decoding device may first generate an initial prediction block by using the block vector. The video decoding device horizontally splits the initial prediction block to generate subblocks. Then, the video decoding device may perform a reordering to change the order of the subblocks to generate a final prediction block of the current block.

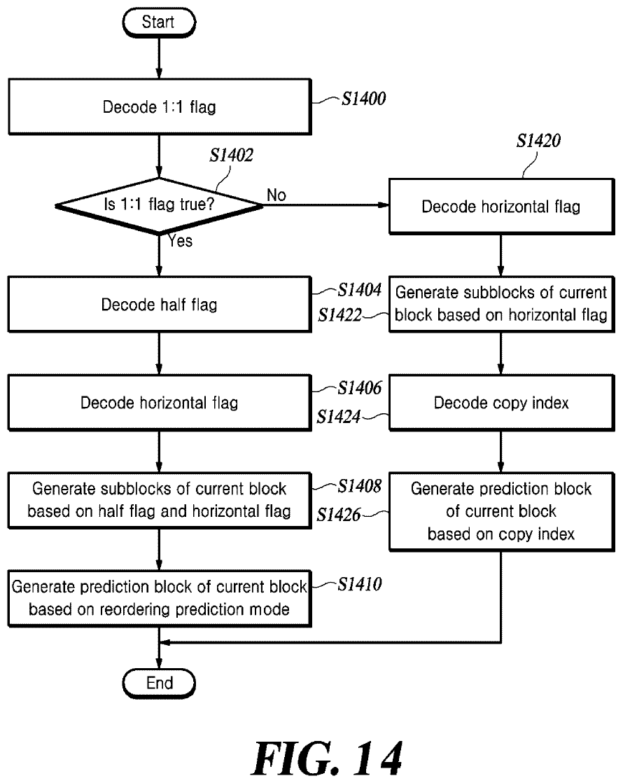

FIG. 14 is a flowchart of a method performed by the video decoding device for predicting a current block based on an IBC mode, according to another embodiment of the present disclosure.

Compared to the flowchart of FIG. 7, the example of FIG. 14 only includes cases where IBC mode is applied and the reorder flag is true.

The video decoding device decodes a 1:1 flag from the bitstream (S1400). Here, the 1:1 flag (1:1_flag) indicates whether the split subblock ratio is 1:1 or 1:1:1:1 in the horizontal or vertical direction. For example, if the 1:1 flag is true, the subblock ratio is 1:1, and if the 1:1 flag is false, the subblock ratio may be 1:1:1:1.

The video decoding device checks the 1:1 flag (S1402).

If the 1:1 flag is true (Yes in S1402), the video decoding device may perform the following steps (S1404 to S1410).

The video decoding device decodes a half flag from the bitstream (S1404). Here, the half flag (half_flag) indicates whether the subblock ratio is 1:1 or 1:2:1 in the horizontal or vertical direction. For example, if the half flag is true, the subblock ratio is 1:1, and if the half flag is false, the subblock ratio may be 1:2:1.

The video decoding device decodes the horizontal flag from the bitstream (S1406). Here, the horizontal flag (hor_flag) indicates whether the current block is horizontally or vertically split.

The video decoding device generates subblocks of the current block based on the half flag and horizontal flag (S1408).

The video decoding device generates a prediction block of the current block based on the reordering prediction mode (S1410).

For example, if the half flag is true and the horizontal flag is false, the video decoding device may perform a reordering prediction to generate a final prediction block of the current block, as illustrated in FIG. 10. Alternatively if the half flag is false and the horizontal flag is false, the video decoding device may perform a reordering prediction to generate the final prediction block of the current block, as illustrated in FIG. 11.

If the 1:1 flag is false (No in S1402), the video decoding device may perform the following steps (S1420 to S1426).

The video decoding device decodes the horizontal flag from the bitstream (S1420). Here, the horizontal flag (hor_flag) indicates whether the current block is horizontally or vertically split.

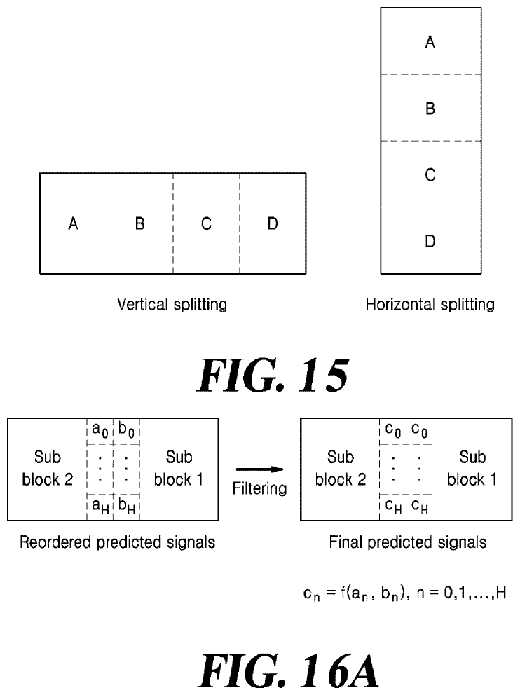

The video decoding device generates subblocks of the current block based on the horizontal flag (S1422). The video decoding device may split the current block to generate the subblocks based on the value of the horizontal flag, as illustrated in FIG. 15.

The video decoding device decodes a copy index from the bitstream (S1424). Here, the copy index (copy_idx) indicates which of the subblocks are to be reordered. If two subblocks are reordered, the reordered blocks according to the copy index may be represented as shown in Table 2.

TABLE 2

| copy_idx | Reordered blocks |
|---|---|
| 0 | A, B |
| 1 | A, C |
| 2 | C, D |
| 3 | B, D |

The video decoding device generates a prediction block of the current block based on the copy index (S1426).

If the current block is implicitly or explicitly split horizontally or vertically, the video decoding device splits the initial prediction block into subblocks and reorders the split subblocks. The video decoding device may then apply filtering to the samples adjacent to the boundaries between the subblocks to generate the final predicted signals, as shown in the following embodiments.

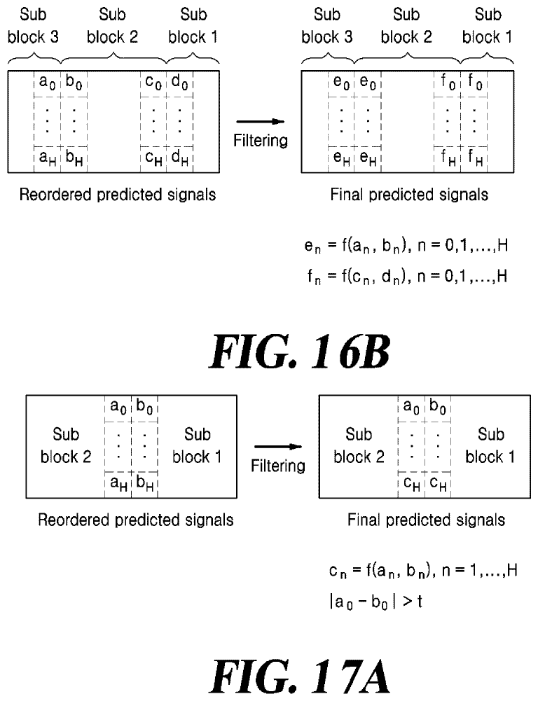

In one example, after performing the reordering of the subblocks with respect to the initial prediction block, the video decoding device may generate the final predicted signals as illustrated in FIGS. 16A and 16B by applying a filter ‘f’ to the predicted signals adjacent to the internal boundaries to generate the signals of the subblock boundaries. In this case, the filter ‘f’ may be a filter, such as a median filter, but may be a fixed filter with a preset coefficient. Alternatively, the video encoding device may signal information indicating one of the preset filters, and the video decoding device may parse the signaled information to determine the filter, and then may use the determined filter to perform filtering on the boundary between the subblocks. At this time, the video decoding device may perform filtering on the boundary between the subblocks by using predicted signals of a region adjacent with respect to the boundary between the subblocks. In the example of FIG. 16A, the initial prediction block is split into two subblocks having a 1:1 ratio. In the example of FIG. 16B, the initial prediction block is split into three subblocks having a 1:2:1 ratio.

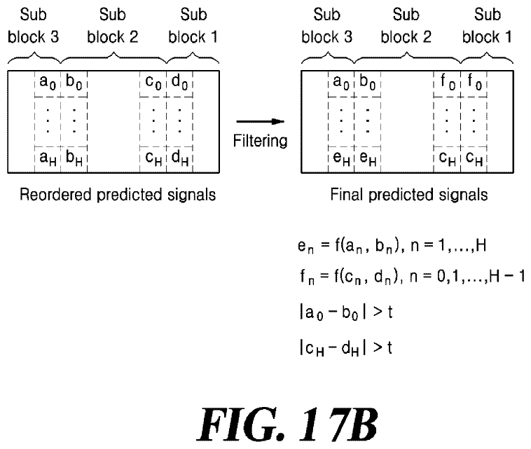

In accordance with another example, after performing the reordering of the subblocks for the initial prediction block, the video decoding device compares the values of the predicted signals at each subblock boundary with those of the predicted signals adjacent to the internal boundary. If the difference between the two adjacent sample values is less than or equal to a certain threshold ‘t’, the video decoding device may generate the final predicted signals as illustrated in FIGS. 17A and 17B by applying a filter ‘f’ to the predicted signals adjacent to the internal boundary to generate the signals of the subblock boundary. On the other hand, if the difference between the two adjacent sample values is greater than a certain threshold ‘t’, the video decoding device may hold from applying filtering to the predicted signals adjacent to the internal boundary. In this case, the threshold may be a predefined value based on an agreement between the video encoding device and the video decoding device. Alternatively, the threshold may be implicitly determined based on the bit depth of the input video. In this case, the filter f may be a filter, such as a median filter, but may be a fixed filter with a preset coefficient. Yet alternatively, the video encoding device may signal information indicating one of the preset filters, and the video decoding device may parse the signaled information to determine the filter, and then may use the determined filter to perform filtering on the boundary between the subblocks. In this case, the video decoding device may perform the filtering of the boundary between the subblocks by using the predicted signals of the region adjacent with respect to the boundary between the subblocks.

In the example of FIG. 17A, the initial prediction block is split into two subblocks having a 1:1 ratio. At this time, the video decoding device may not apply filtering to the boundary between a0 and b0 because |a0−b0|>t is satisfied. Further, in the example of FIG. 17B, the initial prediction block is split into three subblocks with a ratio of 1:2:1. At this time, the video decoding device may not apply filtering to the boundary between a0 and b0 and the boundary between cH and dH, since |a0−b0|>t and |cH−dH|>t are satisfied.

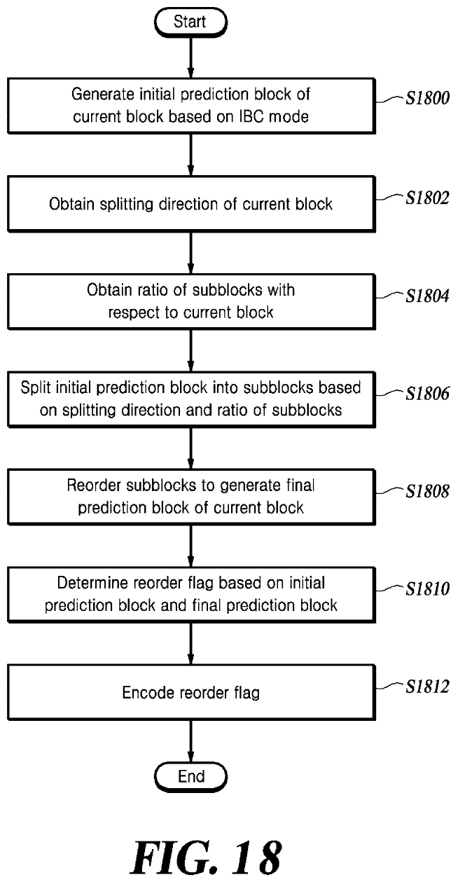

FIG. 18 is a flowchart of a method performed by the video encoding device for predicting a current block based on the IBC mode, according to at least one embodiment of the present disclosure.

The example of FIG. 18 includes a case where the IBC mode is applied.

The video encoding device generates an initial prediction block of the current block based on the IBC mode (S1800).

The video encoding device may generate the block vector of the current block based on the IBC merge mode or the IBC AMVP mode, and then may use the generated block vector to generate the initial prediction block from the reconstructed region in the current frame.

The video encoding device obtains a splitting direction of the current block (S1802). Here, the splitting direction indicates a horizontal split or a vertical split.

In one example, in terms of rate-distortion optimization, the video encoding device determines a horizontal flag. Here, the horizontal flag indicates whether the splitting direction is a horizontal split or a vertical split. The video encoding device may set the splitting direction based on the horizontal flag. Subsequently, the video encoding device may encode and then may signal the horizontal flag to the video decoding device.

As another example, the video encoding device may implicitly determine the splitting direction based on the size of the current block.

The video encoding device obtains a ratio of the subblocks with respect to the current block (S1804).

In one example, in terms of rate-distortion optimization, the video encoding device determines a split index. Here, the split index indicates one of the preset subblock ratios, such as, for example, Table 1. The video encoding device may determine the ratio of the subblocks based on the split index. Subsequently, the video encoding device may encode and signal the split index to the video decoding device.

As another example, the video encoding device may implicitly determine the ratio of the subblocks based on the aspect ratio of the current block.

The video encoding device may split the initial prediction block into subblocks based on the splitting direction and the ratio of the subblocks (S1806).

The video encoding device may reorder the subblocks to generate a final prediction block of the current block (S1808).

The video encoding device may apply a preset filter to samples adjacent to boundaries between the reordered subblocks.

Based on the initial prediction block and the final prediction block, the video encoding device determines a reorder flag (S1810). Here, the reorder flag indicates whether the subblocks are to be reordered. In terms of rate-distortion optimization, the video encoding device may determine the reorder flag by comparing the initial prediction block with the final prediction block. For example, if the initial prediction block is optimal, the video encoding device sets the reorder flag to false. On the other hand, if the final prediction block is optimal, the video encoding device may set the reorder flag to true.

The video encoding device encodes the reorder flag (S1812).

As described above, if a split flag indicating the splitting direction is determined in terms of rate-distortion optimization, the video encoding device may further encode the split flag. Further, if a split index indicating a ratio of the subblocks in terms of the rate-distortion optimization is determined, the video encoding device may encode the split index.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
540: predictor
602: prediction unit-determiner
604: prediction technique-determiner
606: prediction mode-determiner
608: prediction performer

### CROSS-REFERENCE TO RELATED APPLICATIONS

This application claims priority to and the benefit of Korean Patent Application No. 10-2022-0099353 filed on Aug. 9, 2022, and Korean Patent Application No. 10-2023-0089974, filed on Jul. 11, 2023, the entire contents of each of which are incorporated herein by reference.

What is claimed is:

1. A method of reconstructing a current block by a video decoding device, the method comprising:
obtaining a splitting direction of the current block, the splitting direction indicating a horizontal split or a vertical split;
obtaining a ratio of subblocks with respect to the current block;
generating an initial prediction block of the current block according to an intra block copy (IBC) mode;
splitting the initial prediction block into subblocks based on the splitting direction and the ratio of the subblocks; and
generating a final prediction block of the current block by reordering the subblocks.

2. The method of claim 1, further comprising:
decoding, from a bitstream, a reorder flag that indicates whether the subblocks are to be reordered; and
checking the reorder flag,
wherein, when the reorder flag is true, performing obtaining the splitting direction through generating the final prediction block of the current block.

3. The method of claim 2, further comprising, when the reorder flag is false:
generating a prediction block of the current block according to the IBC mode.

4. The method of claim 2, further comprising:
decoding, from the bitstream, an IBC flag indicates whether the IBC mode is to be applied; and
checking the IBC flag,
wherein, when the IBC flag is true, performing decoding the reorder flag.

5. The method of claim 1, wherein obtaining the splitting direction comprises:
decoding, from a bitstream, a horizontal flag that indicates whether the splitting direction is the horizontal split or the vertical split; and
setting the splitting direction according to the horizontal flag.

6. The method of claim 1, wherein obtaining the splitting direction comprises:
implicitly determining the splitting direction based on a size of the current block.

7. The method of claim 1, wherein obtaining the ratio of subblocks comprises:
decoding, from a bitstream, a split index that indicates one of preset ratios of the subblocks; and
determining the ratio of the subblocks according to the split index.

8. The method of claim 1, wherein obtaining the ratio of subblocks comprises:
implicitly determining the ratio of the subblocks based on an aspect ratio of the current block.

9. The method of claim 1, wherein generating the initial prediction block comprises:
generating a block vector of the current block based on an IBC merge mode or an IBC advanced motion vector predictor (AMVP) mode; and
generating, by using the block vector, the initial prediction block from a reconstructed region in a current frame.

10. The method of claim 1, wherein generating the final prediction block comprises:
applying a preset filter to samples adjacent to a boundary between reordered subblocks.

11. The method of claim 10, wherein generating the final prediction block comprises:
applying the preset filter when a difference between two sample values adjacent to the boundary between the reordered subblocks is less than or equal to a preset threshold, and holding from applying the preset filter when the difference between the two sample values is greater than the preset threshold.

12. A method of encoding a current block by a video encoding device, the method comprising:
generating an initial prediction block of the current block according to an intra block copy (IBC) mode;
obtaining a splitting direction of the current block, the splitting direction indicating a horizontal split or a vertical split;
obtaining a ratio of subblocks with respect to the current block;
splitting the initial prediction block into subblocks based on the splitting direction and the ratio of the subblocks; and
generating a final prediction block of the current block by reordering the subblocks.

13. The method of claim 12, further comprising:
determining, based on the initial prediction block and the final prediction block, a reorder flag that indicates whether the subblocks are to be reordered; and
encoding the reorder flag.

14. The method of claim 12, wherein obtaining the splitting direction comprises:
determining a horizontal flag that indicates whether the splitting direction is the horizontal split or the vertical split; and
setting the splitting direction according to the horizontal flag.

15. The method of claim 14, further comprising:
encoding the horizontal flag.

16. The method of claim 12, wherein obtaining the ratio of subblocks comprises:
determining a split index that indicates one of preset ratios of the subblocks; and
determining the ratio of the subblocks according to the split index.

17. The method of claim 16, further comprising:
encoding the split index.

18. A computer-readable recording medium storing a bitstream generated by a video encoding method, the video encoding method comprises:
generating an initial prediction block of a current block according to an intra block copy (IBC) mode;
obtaining a splitting direction of the current block, the splitting direction indicating a horizontal split or a vertical split;
obtaining a ratio of subblocks with respect to the current block;
splitting the initial prediction block into subblocks based on the splitting direction and the ratio of the subblocks; and
generating a final prediction block of the current block by reordering the subblocks.
